(19) United States
(12) Patent Application Publication
(10) Pub. No.: US 2026/0272226 A1
(43) Pub. Date: Sep. 17, 2026

(54) MODULAR COFFEE GRINDER SYSTEM WITH USER-REPLACEABLE AND UPGRADABLE PRECALIBRATED COMPONENTS

(71) Applicant: Raphael HuKai, Honolulu, HI (US)

(72) Inventor: Raphael HuKai, Honolulu, HI (US)

(21) Appl. No.: 19/432,008

(22) Filed: Dec. 23, 2025

Related U.S. Application Data
(60) Provisional application No. 63/770,333, filed on Mar. 11, 2025.

(51) Int. Cl. A47J 42/46; A47J 42/06; A47J 42/08; A47J 42/10; A47J 42/16; A47J 42/18; A47J 42/20; A47J 42/40; A47J 42/44; A47J 42/50

(52) U.S. Cl. CPC A47J 42/46; A47J 42/06; A47J 42/08; A47J 42/10; A47J 42/16; A47J 42/18; A47J 42/20; A47J 42/40; A47J 42/44; A47J 42/50; A47J 2201/00

(57) ABSTRACT

A coffee grinder system and computer-implemented method includes a base, a main chassis mounted to the base, and a rotatable mounting unit interconnected. A burr assembly module having an input portion and an output portion is removably attached to one end of the rotatable mounting unit. A motor module is removably attached to another end of the rotatable mounting unit and to rotates the burr assembly. A feeding attachment has a passageway communicating with the burr assembly module for providing coffee to the burr assembly module. The burr assembly module and the motor module are configured to be removably attached to the rotatable mounting unit without user calibration. Multiple burr assemblies with flat and/or conical burrs are interchangeable based on a desired grind. Multiple motor modules with different torque and/or power profiles are based on the burr assembly power requirement.

This application claims the benefit of priority from U.S. provisional application 63/770,333, filed Mar. 11, 2025, the contents of which are hereby incorporated by reference in its entirety.

### BACKGROUND

### Technical Field

The present disclosure relates to coffee systems, and more particularly to coffee grinders with modular burr assemblies and user-configurable components.

### Description of the Related Art

Besides the quality of the coffee beans and water, the grinder has the greatest influence on coffee flavor. The geometry and size of the burr set, the rotation speed, and the grind size are all key contributing factors. While most grinders on the market today allow users to easily adjust grind size, changing other parameters is far more difficult. For example, switching burr sets typically requires mechanical calibration to reestablish the grind size zero point—a process that demands specialized tools, technical skill, and considerable time.

### SUMMARY

A modular coffee grinder system and computer-implemented method are disclosed. The system includes a base, a main chassis, and a rotatable mounting unit that supports interchangeable burr assembly modules and motor modules. These modules are removably attached without requiring user calibration. The system supports multiple burr geometries (e.g. flat, conical) and motor profiles (e.g. torque, speed), enabling user-driven grind customization. A feeding attachment has a passageway communicating with the burr assembly for providing coffee beans to the burr assembly module, and a dispenser attachment outputs ground coffee. The burr assembly module and the motor module are configured to be removably attached to the rotatable mounting unit without user calibration. Multiple burr assemblies with flat and/or conical burrs are interchangeable based on a desired grind. Multiple motor modules with different torque and/or power profiles are selectable based on the desired grind. A manual drive unit may be mounted to the system in place of the motor module.

In one embodiment, a coffee grinder system includes a base, and a main chassis mounted to the base. A rotatable mounting unit is attached to the main chassis, and the mounting unit has a passthrough port for a shaft from a motor module to provide a driving force to a burr assembly module. The burr assembly module is removably attached to one end of the rotatable mounting unit, the burr assembly module having an input portion and an output portion. A motor module is removably attached to another end of the rotatable mounting unit, the motor module is configured to drive the burr assembly module through a driving shaft via the passthrough port of the rotatable mounting unit; and a feeding attachment is configured to feed coffee particles to the burr assembly module for grinding, the feeding attachment having a passageway communicating with the input portion of the burr assembly module. The burr assembly module and the motor module are configured to be removably attached to the rotatable mounting unit without user calibration.

In an embodiment, which may be combined with the preceding embodiment, the coffee grinder system includes a dispenser attachment configured to receive ground coffee particles from the burr assembly module. The dispenser communicates with an output portion of the burr assembly module.

In an embodiment, which may be combined with one or more of the preceding embodiments, the coffee grinder system includes a plurality of burr assembly modules, each one burr assembly module having a particularly-sized and/or angled set of burrs for respective grinds of coffee.

In an embodiment, which may be combined with one or more of the preceding embodiments, the plurality of burr assembly modules include interchangeable burr sets in multiple sizes and geometry.

In an embodiment, which may be combined with one or more of the preceding embodiments, the coffee grinder system includes a plurality of motor modules, each one motor module having a particular torque and/or power output profile based on power requirements of different burr assemblies.

In an embodiment, a full manual drive system can be employed as well.

In an embodiment, which may be combined with one or more of the preceding embodiments, a rotation speed of the motor module is adjusted based on the desired power need of burrs of the burr assembly module attached to the rotatable mounting unit.

In an embodiment, which may be combined with one or more of the preceding embodiments, the burr assembly module is removably attached to the rotatable mounting unit by one of threads, a snap fitting and/or a twist and lock fitting.

In an embodiment, which may be combined with one or more of the preceding embodiments, the motor module is removably attached to the rotatable mounting unit by a snap fitting and/or a twist and lock fitting.

In an embodiment, which may be combined with one or more of the preceding embodiments, the rotatable mounting unit includes a passthrough port that receives a shaft of the motor module that is coupled to the burr assembly to provide rotational motion.

In an embodiment, which may be combined with one or more of the preceding embodiments, an interface port provides digital connectivity such for as universal serial bus (USB).

In an embodiment, which may be combined with one or more of the preceding embodiments, the base includes a communication module configured for wired or wireless communication with the components of the grinder system, as well as external smart appliances.

In an embodiment, which may be combined with one or more of the preceding embodiments, the coffee grinder system includes a second power module and a second communication module for communication with the first communication module.

In an embodiment, which may be combined with one or more of the preceding embodiments a control module is configured to control operations of the components of the grinder system, running Apps that interact internally within the grinder system, as well as with external systems.

In an embodiment, which may be combined with one or more of the preceding embodiments, the control module transmits and receives communication via the communication module by wire and/or wirelessly.

In an embodiment, which may be combined with one or more of the preceding embodiments, the feeding assembly further includes a bean hopper with an integrated scale, and wherein a grinding timer can be triggered by the bean hopper.

In an embodiment, which may be combined with one or more of the preceding embodiments, and wherein a smartphone app configured to provide selections for coffee grinding operations communicates with the control module via the communication module.

In an embodiment, which may be combined with one or more of the preceding embodiments the control module is configured to apply grinding profiles including grind by weight or time.

In an embodiment, which may be combined with one or more of the preceding embodiments, the chassis includes a passageway for cables/pipes and an upper surface and a plurality of removable tiles arranged at an upper surface for customizable arrangement of accessories.

In one embodiment, a smartphone application executes a method for customized coffee grinding. The app receives user input, retrieves grind profiles from a cloud database, transmits control signals to the grinder, and updates grind parameters based on sensor feedback.

### BRIEF DESCRIPTION OF THE DRAWINGS

The drawings are of illustrative embodiments. They do not illustrate all embodiments. Other embodiments may be used in addition to or instead of. Details that may be apparent or unnecessary may be omitted to save space or for more effective illustration. Some embodiments may be practiced with additional components or steps and/or without all the components or operations that are illustrated. When the same numeral appears in different drawings, it refers to the same or like components or operations.

A better understanding of the present disclosure can be obtained when the following detailed description is considered in conjunction with the following drawings, in which:

FIG. 1 illustrates a perspective view of a coffee grinder system according to an illustrative embodiment.

FIG. 2 shows another perspective view of a coffee grinder system according to another illustrative embodiment with a horizontally oriented burr assembly module.

FIG. 3 shows a perspective view of a vertically oriented configuration of the coffee grinder system according to another illustrative embodiment

FIG. 4 shows a coffee grinder system having a pivotable configuration with modular accessories, according to another illustrative embodiment.

FIG. 5 provides some non-exhaustive examples of the types of attachments that may be used for connecting components, according to an illustrative embodiment.

FIG. 6 shows non-limiting examples of a burr assembly module, motor module, and mounting unit, according to an illustrative embodiment.

FIG. 7 shows a base that houses some components of the apparatus, and an array of blank tiles, some of which may be replaced with additional accessories, according to an illustrative embodiment.

FIG. 8 shows implementation of some of the accessories that can be added in the positions of the blank tiles shown in FIG. 7.

FIG. 9 illustrates a flowchart of a computer-implemented method for customized coffee grinding, executed via a smartphone application, according to another illustrative embodiment.

FIG. 10 shows one example of a burr set with ghost teeth, according to an illustrative embodiment.

### DETAILED DESCRIPTION

In the following detailed description, numerous specific details are set forth by way of examples to provide a thorough understanding of the relevant teachings. However, it should be understood that the present teachings may be practiced without such details. In other instances, well-known methods, procedures, components, and/or circuitry have been described at a relatively high level, without detail, to avoid unnecessarily obscuring aspects of the present teachings. \

It is to be understood that the components illustrated and described herein are provided by way of example, and that variations in number, configuration, and arrangement are contemplated. Additional components may be included, certain components may be omitted, and the illustrated arrangements may be modified or combined in alternative ways without departing from the scope of the appended claims.

### Overview

The present disclosure relates to a modular burr assembly module designed for interchangeable use in a coffee grinding system. The burr assembly module is pre-packaged with a burr set (flat, conical, or other geometry, and a size of a designer's choice), and connects to a standardized mounting interface, allowing tool-free replacement and enhanced user customization. Replacing of the burr assembly module can be performed by the user without the need of a recalibration procedure to reset the zero grind setting. A user can adjust the grind size to “dial in” coffee any time without performing the zero setting calibration.

Conventional coffee grinders use fixed burr assemblies that require complex recalibration whenever burrs are replaced. As a result, it is often impractical to use a single grinder for multiple brewing methods or to achieve a variety of flavor profiles. Consequently, consumers are forced either to settle for one burr configuration with limited versatility or to purchase multiple grinders, which is costly and inconvenient.

In conventional systems, the calibration process, is typically performed during initial setup or following burr replacement for maintenance. It ensures that subsequent grind size adjustments are accurately referenced to the true zero position. However, in the coffee grinder system according to the present disclosure, the user can easily change burr sets without the need to perform the zero grind calibration.

It is to be understood by persons of ordinary skill that zero reference point for grind size is different than a grind size adjustment operable by the user. This adjustment allows selection of a desired grind size (e.g., espresso, drip, or French press) based on the calibrated zero setting. For example, a user may select a grind size value of 12 for espresso or 45 for drip coffee, where such values are indexed relative to the zero setting established during calibration.

Additionally, the coffee grinder system according to the present disclosure may include the power and digital signal connection from a mounting system provides for smart/powered attachments. An integrated airpipe can provide airflow for retention reduction in the burr set, as well as the coffee dispenser attachment. The integrated airpipe can also be used by vacuum accessories for easy cleaning.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

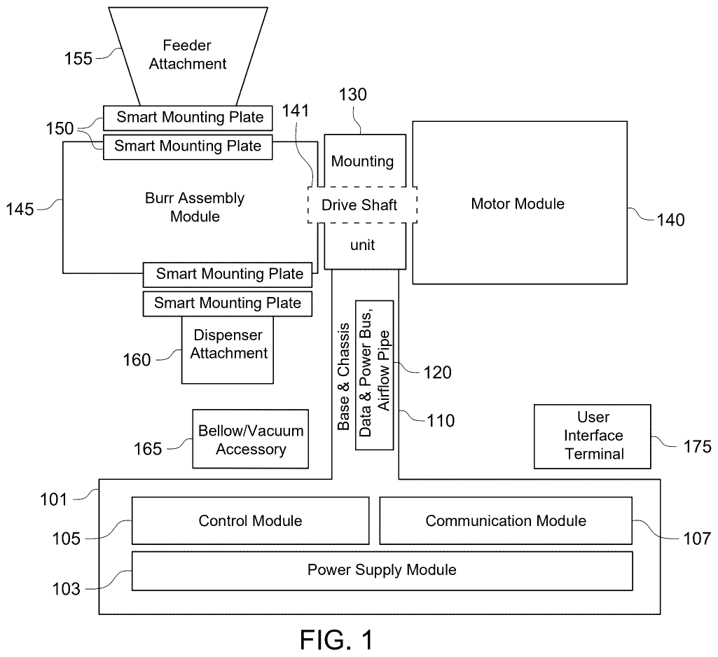

FIG. 1 illustrates a perspective view of a coffee grinder system 100. It is to be understood that the coffee grinder system in FIG. 1 is provided for illustrative purposes, and the appended claims are not limited by the drawings shown herein. There may be fewer elements than shown, or more, and certain components may be combined.

The coffee grinder system 100 includes a base 101 and a main chassis 110. A rotatable mounting unit 130 is attached to the chassis and includes a passthrough port for a motor shaft 141. The mounting unit supports power and digital connectivity 120, and an airflow pipeline.

A burr assembly module 145 is removably attached to one end of the mounting unit. It includes an input portion connected to a feeder attachment 155 and an output portion aligned with a dispenser attachment 160. A motor module 140 is attached to the opposite end and drives the burrs via the shaft 141. Both modules are attached without calibration, using snap fittings or twist-lock mechanisms.

The feeder attachment 155 delivers coffee beans to the burr assembly. Airflow may pass through the burr assembly into both the feeder and dispenser attachments. The dispenser 160 receives ground coffee and may trigger motor activation via a push mechanism. A grinding timer may initiate grinding based on bean detection. Both the feeder attachment 155 and the dispenser attachment 160 are designed to be used with any burr assembly through the standard connection ports. It is to be understood that the initiation of a grinding operation is not limited to bean detection. For example, the grinding timer could be set for a specific future time to start a grinding operation, or by a smartphone command, or manually tapping or turning an on switch. Voice commands may also be used to initiate grinding, particularly if the grinder system is part of an Internet of Things (IoT) network.

Multiple burr assembly modules are supported, each with specific burr geometries and sizes. These may include flat or conical burrs in various dimensions. Motor modules may vary in torque and power output, allowing flavor customization based on grind dynamics.

The base 101 houses a control module 105, power supply module 103, and the communication module 107. These components manage motor control, power delivery, and wired/wireless communication. The rotatable mounting unit 130 has a passthrough port for a shaft 141 from a motor module 140, which in turn, drives the burr assembly unit 145. The rotatable mounting unit 130 includes a power connection for an electric motor, standard digital connectivity points, as well as an airpipe line 120. A user interface terminal 175 may include a touchscreen, display, or button array for grinder operation. There may be a speaker (not shown) to provide audio along with a visual display. Optional accessories include a bellow/vacuum module 165 for clearing bean pathways.

A burr assembly module 145 is removably attached to one end of the rotatable mounting unit 130. The burr assembly module 145 has an input portion and an output portion for feeder attachment 155 and dispenser attachment 160. Both the feeder attachment 155 and the dispenser attachment 160 are reusable to fit different burr assemblies. A motor module 140 is removably attached to another end of the rotatable mounting unit 130. The motor module 140 is configured to rotate blades of the burr assembly module 145 via the shaft that pass through the mounting unit 130.

The burr assembly module 145 and the motor module 145 are configured to be removably attached to the rotatable mounting unit 130 without zero point calibration. In some illustrative embodiments, the burr assembly module 145 may be removably attached to the rotatable mounting unit 130 by a snap fitting and/or twist and lock fitting. In some other illustrative embodiments, the burr assembly module 145 is removably attached to the rotatable mounting unit by a configuration of threads and grooves.

A feeder attachment 155 is configured to feed coffee beans and/or particles to the burr assembly module 145 for grinding, the feeding assembly having a passageway communicating with the input portion of the burr assembly module 145. Airflow can pass through from the burr assembly module 145 into the feeder attachment 155 and the dispenser attachment 160.

Still referring to FIG. 1, the dispenser attachment 160 is configured to receive ground coffee particles from the burr assembly module, the dispenser attachment communicates with an output portion of the burr assembly module 145. Airflow can pass through from the burr assembly module 145 into the dispenser attachment 160. Pushing a switch on the dispenser 115 starts the motor. Then the timer starts when beans are in the grinder.

With regard to the burr assembly module 145, the coffee grinder system may be provided with a plurality of burr assembly modules, each one burr assembly module having a particularly-sized and/or angled set of burrs for respective grinds of coffee. Moreover, the plurality of burr assembly modules may have interchangeable flat burr sets, and conical burr sets in multiple sizes. Each burr type and size will grind the coffee in a way that impacts the flavor of coffee.

With regard to the motor module 140, the coffee grinder system 100 may include a plurality of motor modules. In addition, there may be a manually driven motor. Each one of the plurality of motor modules may have a particular torque and/or power output profile based on specific burr assemblies. Moreover, the rotation speed of the motor module 145 may be set based on the particularly-sized and/or angled set of burrs of the burr assembly module 145 attached to the rotatable mounting unit 130. In other words, the coffee grinder system is customizable.

The base 101 of the coffee grinder system 100 includes a control module 105 configured to control the motor module, and a power supply module 103 configured to provide power to the motor module 140, or to the whole grinder system. It is to be understood throughout, that the components are shown for explanatory purposes and the appended claims are not limited to the embodiments shown in the drawings. Moreover, the components arranged in the base 101 are not limited to what is shown in the drawings. More components, fewer components, and/or other components may be arranged in the base 101. The control module 105 can be individually replaced, upgraded, extended, without affecting other components of the grinder system.

The base 101 may further include a communication module 107 configured for wired or wireless communication with the control module 105, the communication module 107, and the power supply module 103. The communication module 107 can be individually replaced, upgraded, extended, without affecting other components of the grinder system.

A user terminal interface 175 communicates with the communication module 107 to control operations of the coffee grinder. The user terminal interface 175 may be a touchpad, or a display, or even a series of buttons (physical or software buttons) that may be used to control various settings of the coffee grinder. The user terminal interface 175 can be individually replaced, upgraded, extended, without affecting other components of the grinder system.

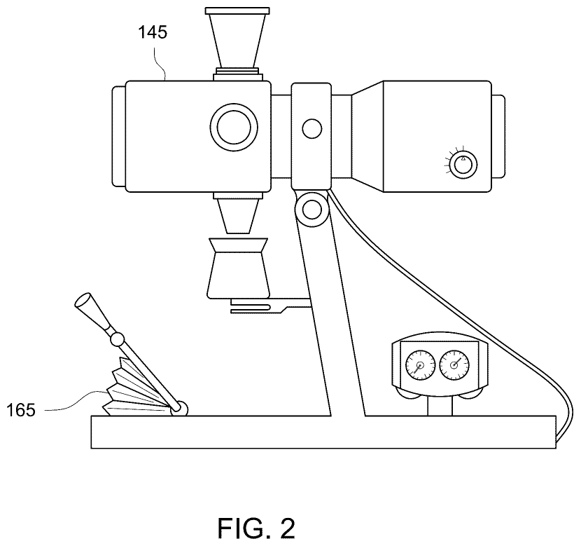

As shown in FIGS. 1 and 2, an optional bellows/vacuum accessory 165 is provided to clean the path of beans from the burr assembly 145, the feeder attachment 155 and the dispenser attachment 160.

FIG. 2 shows another perspective view of a coffee grinder system according to another illustrative embodiment with a horizontally oriented burr assembly module. The horizontal or tilted orientations are generally more suitable for flat burr set.

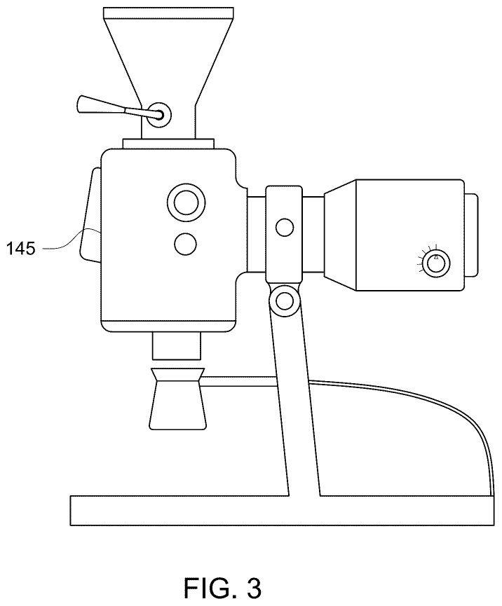

FIG. 3 shows a perspective view of a vertically oriented configuration of the coffee grinder system according to another illustrative embodiment The vertically oriented configuration is generally more suitable for conical burr set.

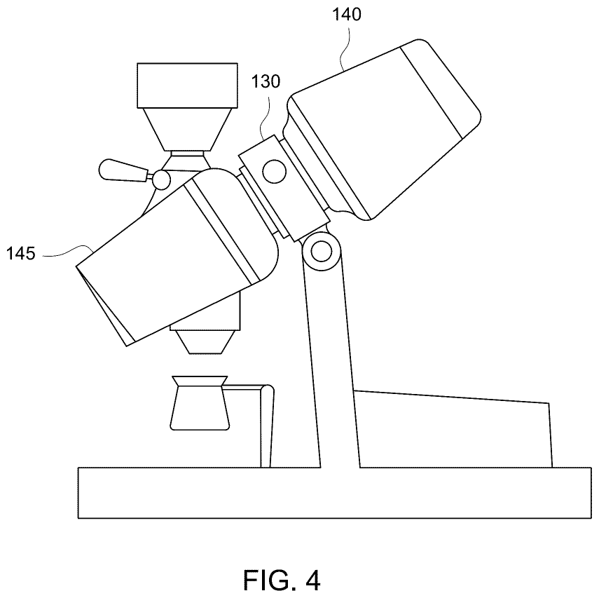

FIG. 4 shows pivotable configuration of a coffee grinder system with modular accessories, according to another illustrative embodiment. The chassis surface may include customizable tile arrangements under which some of the electronics may be arranged, and cables routed between components. For example, the mounting unit 130, burr assembly module 145, and motor module 140 are pivotable about the chassis.

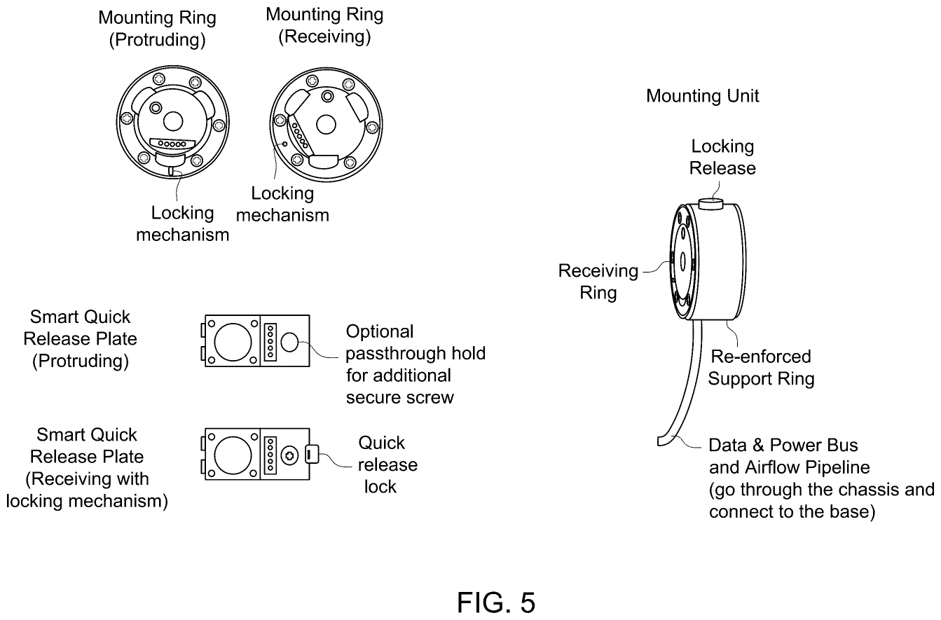

FIG. 5 provides some non-exhaustive examples that show how the components may be mounted, according to an illustrative embodiment. For example, the components may attach by threads, snap fittings, or twist and lock constructions. FIG. 5 illustrates various attachment mechanisms that may be employed to secure modular components of the coffee grinder system. These items include: A mounting ring (protruding) and a mounting ring (receiving) pair that enables rotational locking; a smart quick-release plate with a locking mechanism for tool-free securement; a reinforced support ring that provides structural stability; a data and power bus and airflow pipeline that pass through the chassis and connect to the base; and an optional passthrough hole for additional screw-based securement. A locking release tab enables user disengagement of modules. All of the aforementioned mechanisms support interchangeable burr and motor modules while maintaining alignment, connectivity, and airflow integrity.

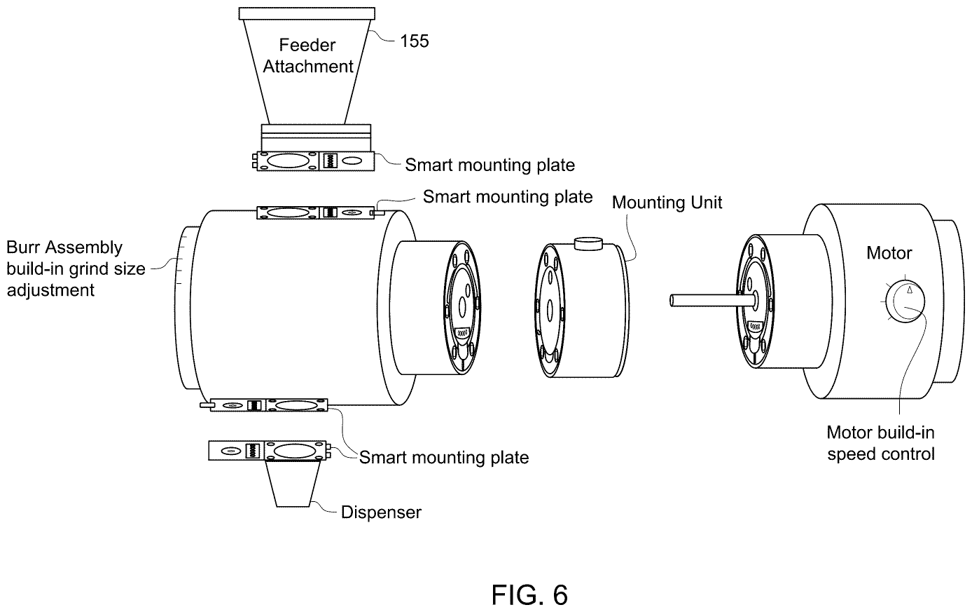

FIG. 6 shows non-limiting examples of a burr assembly module, motor module, and mounting unit, according to an illustrative embodiment. FIG. 6 shows modular components including: A burr assembly module with built-in grind size adjustment; a motor module with integrated speed control; a mounting unit that interfaces with both modules and supports smart mounting plates; the feeder attachment and dispenser attachment are shown in alignment with the burr assembly module. Smart mounting plates may include embedded electronics for identification, power delivery, or control signaling. These components are designed to be user-replaceable and support dynamic grind customization.

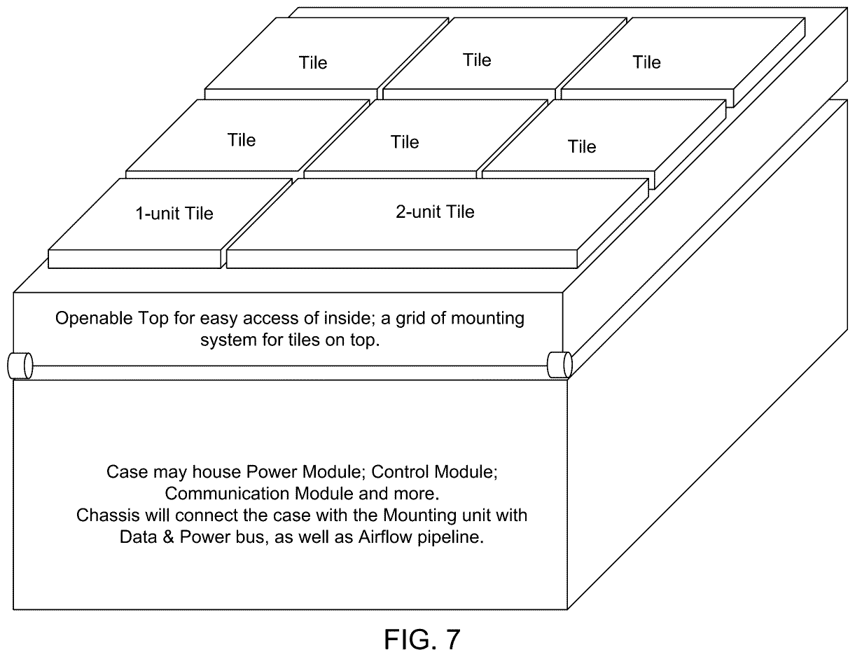

FIG. 7 shows a base that houses some components of the apparatus, and an array of blank tiles, some of which may be replaced with additional accessories, according to an illustrative embodiment. More particularly, FIG. 7 illustrates the base and chassis configuration with a tile-based accessory grid. The chassis includes: an openable top for internal access; a grid of mounting positions for tiles, which may be, for example, 1-unit or 2-unit in size. The base may house the power module, control module, and communication module, which interface with the mounting unit via a data and power bus and airflow pipeline. This modular tile system enables users to customize the grinder layout with functional or aesthetic accessories.

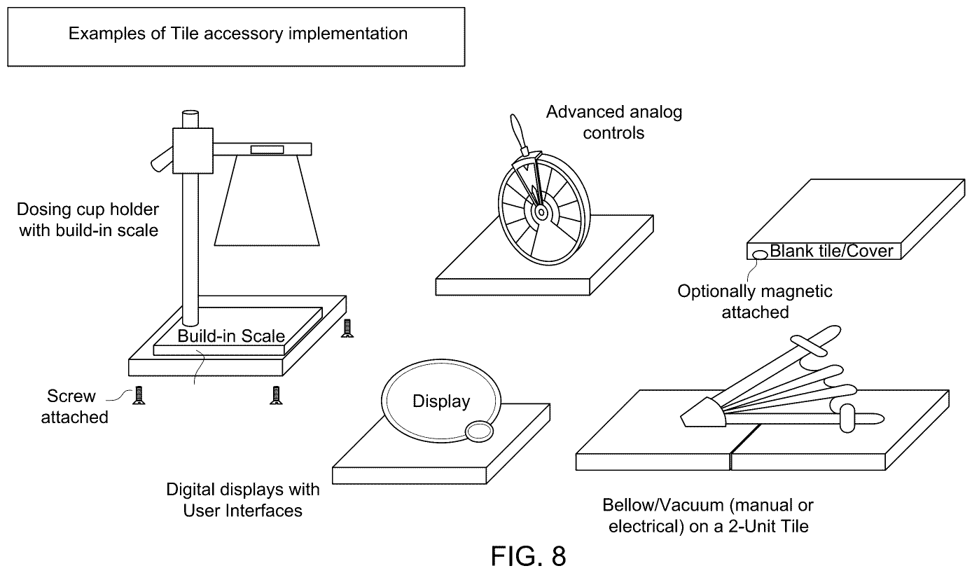

FIG. 8 shows implementation of some of the accessories that can be added in the positions of the blank tiles shown in FIG. 7. FIG. 8 provides examples of tile-mounted accessories, including: A dosing cup holder with a built-in scale; advanced analog controls and digital displays with user interfaces; a bellow/vacuum module, which may be manual or electric, mounted on a 2-unit tile; blank tiles or covers that may be screw-attached or magnetically secured. These accessories enhance usability and allow for personalized grinder configurations.

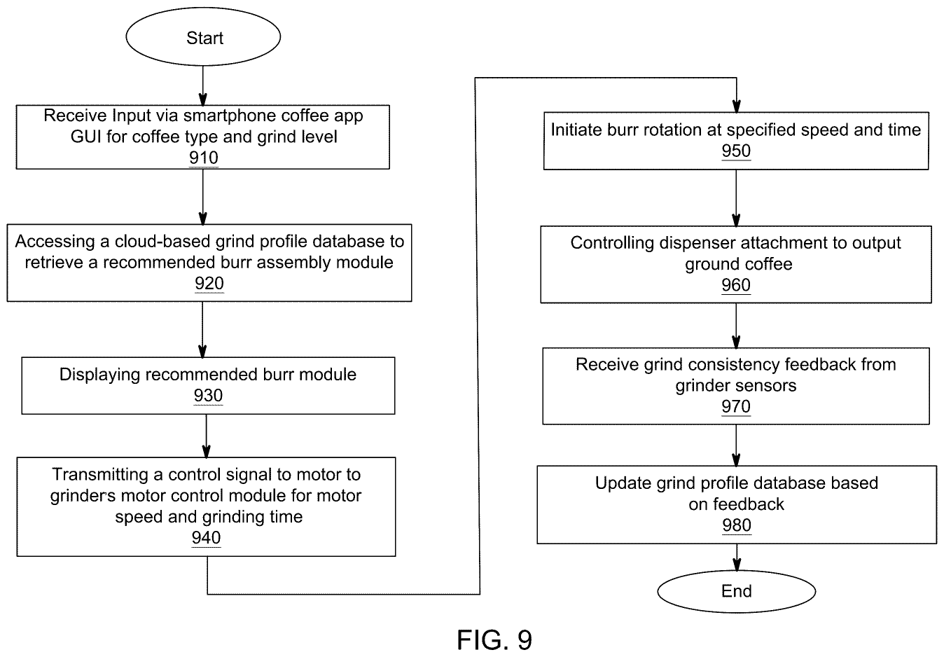

FIG. 9 illustrates a flowchart of a computer-implemented method for customized coffee grinding, executed via a smartphone application. FIG. 9 is shown as a collection of blocks, in a logical order, which represents a sequence of operations that can be implemented in a combination thereof. FIG. 9 is provided for explanatory purposes and the appended claims are not limited to the operations shown and described in FIG. 9. It is to be understood that the logic order of the blocks may be different than shown, and the sequence of operations may be longer or shorter than shown. The logic operations may also be combined into fewer blocks than shown in FIG. 9.

The computer-implemented method enables dynamic control of a modular coffee grinder system based on user input and real-time feedback. Each step corresponds to a functional operation performed by the smartphone application and/or the grinder system. It is to be understood that application, while being executed by a smartphone in this illustrative embodiment, may also be operated by a dedicated remote attachment that is provided with the coffee grinder or sold separately. Also, the user interface terminal 175 may be configured to perform some and/or all of the operations shown in FIG. 9 and discussed hereinbelow.

At step 910, the method begins with receiving a user input via a graphical user interface (GUI) of the smartphone application. The input includes a selection of a type of coffee and a desired grind level.

At step 920, the smartphone application accesses a cloud-based grind profile database to retrieve an identifier of a burr assembly module recommended for the selected type of coffee and grind level. The grind profile database may include predefined associations between coffee types, grind levels, burr geometries, and motor parameters.

At step 930, the smartphone application displays an output identifying the recommended burr assembly module for usage. This may include a visual or textual indication of the burr module's geometry, size, or configuration.

At step 940, the smartphone application transmits a control signal via a wireless communication module (e.g., Bluetooth or WiFi) to a motor control module of the coffee grinder. The control signal includes a motor speed and a grinding time associated with the recommended burr assembly module.

At step 950, the motor control module initiates rotation of burrs of the burr assembly module at the specified motor speed for the designated grinding time. The burrs grind the coffee beans according to the selected grind level.

At step 960, the system controls a dispensing module to output the ground coffee to a dispenser. The dispensing module may include a chute, port, or receptacle aligned with the output portion of the burr assembly module.

At step 970, the system receives feedback data from a sensor module of the coffee grinder. The feedback data is indicative of grind consistency, and may include measurements of particle size, flow rate, or other physical parameters.

At step 980, the smartphone application updates the grind profile database based on the received feedback data. This enables refinement of future grinding parameters and supports adaptive control for improved grind accuracy over time.

The method concludes after step 980, completing a full cycle of customized coffee grinding based on user preferences and real-time system feedback.

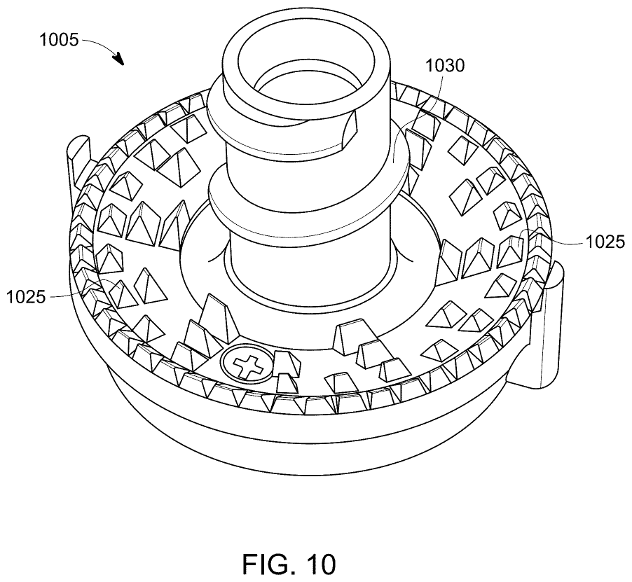

FIG. 10 shows one example of a burr set 1005 with ghost teeth 1025, according to an illustrative embodiment. It is to be understood that the burr set 1005, which is part of a burr module, is shown for illustrative purposes. Many other arrangements/types of burr sets are contemplated with the grinder according to the present disclosure. In the particular burr set 1005, the ghost teeth may be approximately 64 mm and are arranged in a pattern to grind the beans in a manner that will impact the flavor of coffee brewed from the beans. Again, it is to be understood that 64 mm is not a limitation regarding the size (as well as shape or pattern) of the burr sets that may be used. Also shown are threads 1030, which may be provided for modular installation of the burr set 1005.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A coffee grinder system comprising:
a base;
a main chassis mounted to the base,
a rotatable mounting unit attached to the main chassis, the rotatable mounting unit having at least one power connector;
a burr assembly module removably attached to one end of the rotatable mounting unit, the burr assembly module having an input portion and an output portion
a motor module removably attached to another end of the rotatable mounting unit, the motor module includes a driving shaft that passes through the rotatable mounting unit to couple with and drive the burr assembly module; and
a feeder attachment configured to feed coffee particles to the burr assembly module for grinding, the feeder attachment having a passageway communicating with the input portion of the burr assembly module;
wherein the burr assembly module and the motor module are configured to be removably attached to the rotatable mounting unit, without user calibration.

2. The coffee grinder system according to claim 1, further comprising a dispenser attachment configured to receive ground coffee particles from the burr assembly module, the dispenser attachment configured to substantially align with an output portion of the burr assembly module.

3. The coffee grinder system according to claim 2, further comprising a plurality of burr assembly modules that are user-selectable, each one burr assembly module having a particularly-sized and/or angled set of burrs for respective grinds of coffee, and are configured to attach to the rotatable mounting unit.

4. The coffee grinder system according to claim 3, wherein the plurality of burr assembly modules comprises interchangeable burr sets in multiple sizes.

5. The coffee grinder system according to claim 3, further comprising a plurality of motor modules, each one motor module having a particular torque and/or power output profile based on one or more respective grinds of coffee.

6. The coffee grinder system according to claim 5, wherein a rotation speed of the motor modules can be adjusted based on the particularly-sized and/or angled set of burrs of the burr assembly module attached to the rotatable mounting unit and their specific power requirements.

7. The coffee grinder system according to claim 1, wherein the burr assembly module includes a snap fitting configured to removably attach to the rotatable mounting unit.

8. The coffee grinder system according to claim 1, wherein the burr assembly module includes a twist and lock fitting configured to removably attach to the rotatable mounting unit.

9. The coffee grinder system according to claim 1, wherein the burr assembly module includes threads configured to removably attach to the rotatable mounting unit.

10. The coffee grinder system according to claim 1, wherein the burr assembly module includes a snap fitting and/or a twist and lock fitting for removable attachment to the rotatable mounting unit.

11. The coffee grinder system according to claim 1, wherein the rotatable mounting unit includes an interface port for digital connectivity.

12. The coffee grinder system according to claim 11, wherein the interface port comprises a universal serial bus (USB) port with power delivery.

13. The coffee grinder system according to claim 1, wherein the rotatable mounting unit includes an integrated airpipe; and
a dedicated power connection for the motor module.

14. The coffee grinder system according to claim 1, further comprising a power module configured to provide power to at least the motor module.

15. The coffee grinder system according to claim 12, wherein the base further includes a communication module configured for wired or wireless communication.

16. The coffee grinder system according to claim 1, wherein the feeder attachment further comprises a bean hopper with an integrated scale, and
wherein a grinding timer is triggered by activation of the bean hopper.

17. The coffee grinder system according to claim 16, wherein a display is configured to provide selections to a control module for coffee grinding operations via a communication module.

18. The coffee grinder system according to claim 17, further comprising a control module configured to apply grinding profiles including grind by weight or time.

19. The coffee grinder system according to claim 17, wherein the display comprises a touchscreen, and a speaker provides an audio output.

20. The coffee grinder system according to claim 1, wherein the main chassis includes a passageway for cables and an upper surface and a plurality of removable tiles arranged at an upper surface for customizable arrangement of accessories.

21. A computer-implemented method, executed by a smartphone, for customized coffee grinding, the computer-implemented method comprising:
receiving, via a graphical user interface of the smartphone, a user input indicative of a type of coffee and a desired grind level;
accessing, via the smartphone, a cloud-based grind profile database to retrieve an identifier of a burr assembly module recommended for the type of coffee and desired grind level;
displaying, via the smartphone, an output identifying the recommended burr assembly module for usage;
transmitting, via a wireless communication module of the smartphone, a control signal to a motor control module of a coffee grinder, the control signal comprising a motor speed and a grinding time associated with the recommended burr assembly module;
initiating, via the motor control module, rotation of burrs of the burr assembly module at the motor speed for the grinding time to grind the coffee;
controlling a dispensing module to output ground coffee to a dispenser;
receiving, via a sensor module of the coffee grinder, feedback data indicative of grind consistency; and
updating, via the smartphone, the grind profile database based on the feedback data to refine future grinding parameters.

22. The computer-implemented method according to claim 21, wherein the wireless communication module comprises at least one of Bluetooth and/or WiFi communication module.
